(19) United States
(12) Patent Application Publication
(10) Pub. No.: US 2005/0206989 A1
(43) Pub. Date: Sep. 22, 2005

(54) Electro-absorption modulator with broad optical bandwidth

(76) Inventor: John Haig Marsh, Glasgow (GB)

Correspondence Address: DASPIN & AUMENT, LLP, 210 WEST 22ND STREET, SUITE 102, OAK BROOK, IL, 60523, US

(21) Appl. No.: 10/507,670

(22) PCT Filed: Mar. 14, 2003
(86) PCT No.: PCT/GB03/01083

§ 371 Date: Apr. 11, 2005

(30) Foreign Application Priority Data
Mar. 16, 2002 (GB) 0206226.3

(51) Int. Cl. G02F 1/03

(52) U.S. Cl. 359/245

(57) ABSTRACT

An electro-absorption modulator comprises a waveguiding structure including a plurality of sections (201-205), each section having a different bandgap and at least one electrode for applying electrical bias to the section. An optical signal passing through the waveguiding structure may be modulated using the plurality of separately addressable sections, by applying a modulation signal to one or more of the sections, and electrically biasing one or more of the sections with a bias voltage, in such a manner as to achieve a predetermined level of any one or more of the parameters chirp, modulation depth and insertion loss.

The present invention relates to electro-absorption modulators (EAMs).

Waveguide electro-absorption modulators (EAMs) are very compact devices suitable for modulating light at data rates of 10 Gb/s and higher. They are used in optical communication networks with a typical reach currently of 50 km, but likely extending to 100 to 120 km in the near future. Optimised devices would have application in even longer reach systems.

Their compact size (typically having a waveguide length of a few hundred μm), low drive voltage (typically <5V) and compatibility with semiconductor lasers in terms of mode size make them ideal for use as external modulators. They can advantageously be packaged within the same module as the semiconductor laser or integrated on chip with the semiconductor laser.

The principle of operation of EAMs is based on the quantum confined Stark effect (QCSE) in semiconductor quantum well (QW) devices. In a QW structure, the effective bandgap is determined by the fundamental material bandgap of the QW and the quantisation energies of the electron and hole levels. When an electric field is applied to the device perpendicular to the well, the effective bandgap is reduced, and the absorption spectrum changes. This allows the amplitude of light transmitted through the devices to be modulated. When the absorption spectrum changes, there is an accompanying change in the refractive index of the structure (Kramers-Krönig relation). The change in refractive index causes a change in optical path length, in turn causing dynamical changes in the wavelength of the transmitted light. These changes in the wavelength of a transmitted optical pulse are known as chirp. Chirp has the effect of modifying the range that data can be transmitted along an optical fibre because of fibre dispersion.

There is a trade-off between chirp, insertion loss and modulation depth that means such devices have a limited wavelength range of operation.

Existing EAMs in the prior art have a single bandgap. This limits the range of wavelengths over which the device will operate. Electrorefraction modulators make use of refractive index changes in waveguide sections arising from applied voltages and will work over a broad wavelength range. These devices can take the form of integrated interferometers (e.g. Mach-Zehnder) or directional coupler configurations fabricated in materials including lithium niobate or semiconductors including GaAs and InP-based structures. Such devices are very long—several centimetres in length—which is a significant disadvantage in communication systems where space is at a premium.

It is an object of the present invention to provide an electro-absorption modulator that overcomes at least some of the disadvantages associated with prior art devices.

In one aspect, the present invention provides a multi-bandgap electro-absorption modulator, capable of covering a broad optical bandwidth (>40 nm) with low chirp, low insertion loss and high modulation depth (>10 dB).

In another aspect, the present invention provides a method of modulating an optical signal passing through a waveguide to achieve desired levels of chirp, modulation depth and insertion loss.

The EAM described herein has a broad wavelength range of operation, but is compact compared to an electro-refractive device.

The EAM described herein may be integrated monolithically with a source laser.

According to one aspect, the present invention provides an electro-absorption modulator comprising a waveguiding structure including a plurality of sections, each section having a different bandgap and at least one electrode for applying electrical bias to the section.

According to another aspect, the present invention provides a method of modulating an optical signal passing through a waveguiding structure having a plurality of separately addressable sections, each section being formed from a semiconductor medium having a predetermined bandgap and an electrode for biasing said medium, the method comprising the step of:
electrically biasing one or more of said sections with a bias voltage in such a manner as to achieve a predetermined level of any one or more of the parameters chirp, modulation depth and insertion loss.

Embodiments of the present invention will now be described by way of example and with reference to the accompanying drawings in which:

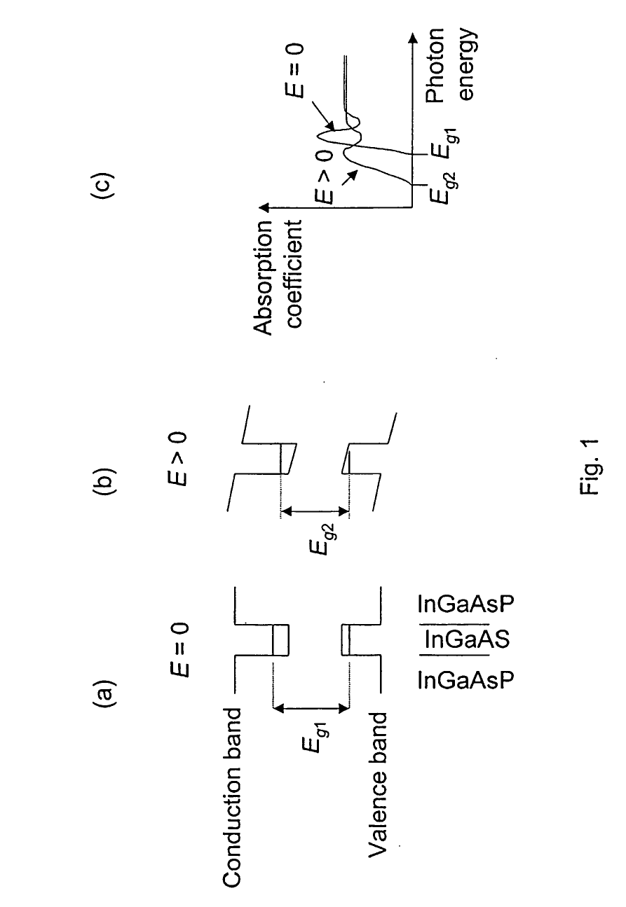

FIGS. 1(a), 1(b) and 1(c) show schematic diagrams useful in illustrating the principle of the quantum confined Stark effect;

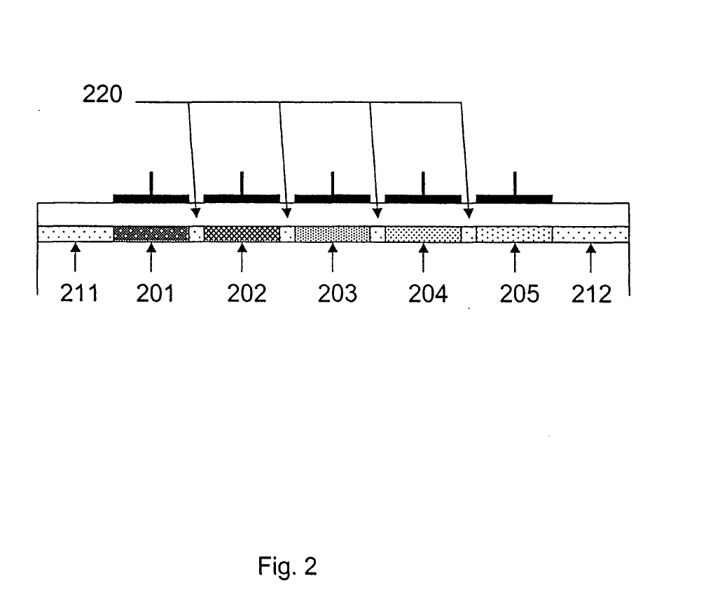

FIG. 2 shows a cross-section along the axial length of the waveguide of a device according to one embodiment of the present invention;

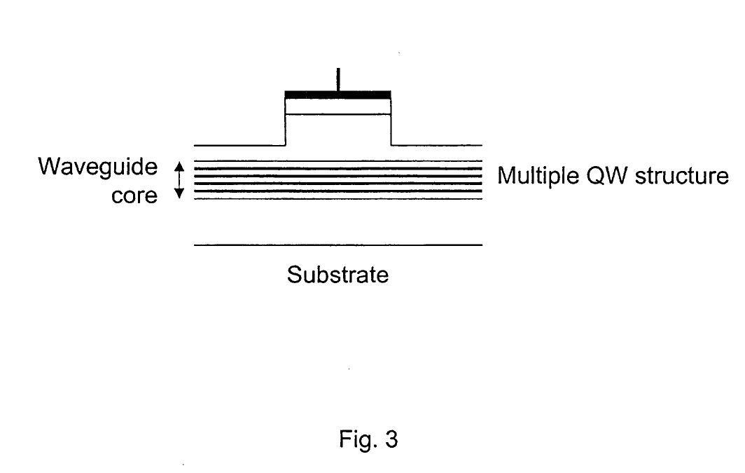

FIG. 3 shows a cross-section perpendicular to the waveguide axis through the device of FIG. 2; and

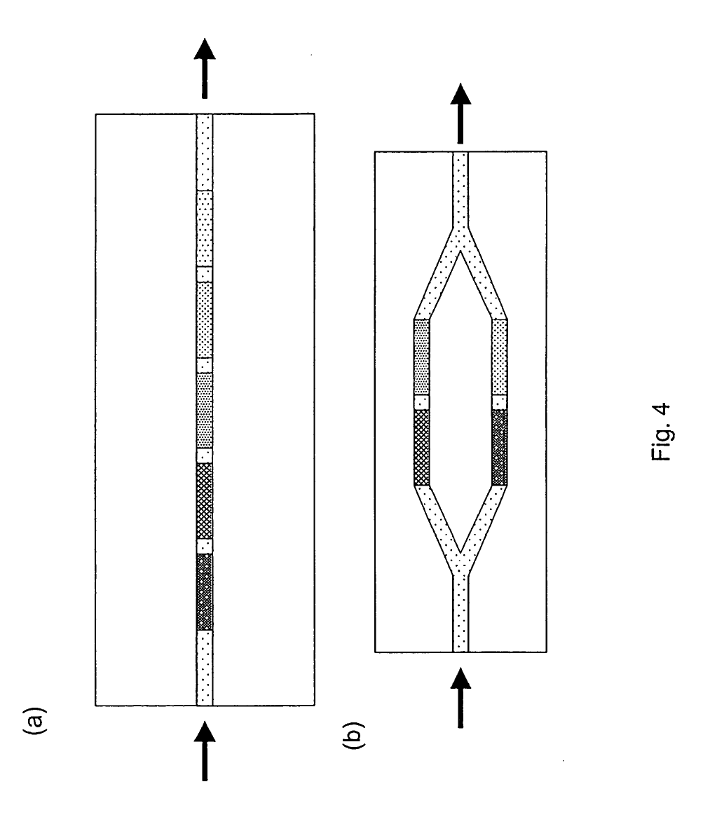

FIGS. 4(a) and 4(b) show schematic plan views respectively of series and parallel configurations of an electro-absorption modulator according to the present invention.

Described herein is an electro-absorption waveguide modulator split into sections each with a different bandgap and in which each bandgap section is addressed by a separate electrode. Each bandgap section will give optimised performance, in terms of chirp and modulation depth, over a range of wavelengths.

One or more electrical modulation signals, representing data, are applied to one or more sections of the device to impose the data on the optical signal produced by the modulator. In addition to the electrical modulation, the one or more sections to which the electrical modulation signals are applied may also be pre-biased with a dc electrical voltage.

The remaining sections of the device to which modulation signals are not being applied may also or instead be biased with one or more dc bias voltages.

The dc bias voltage or voltages may include any of a reverse bias, zero bias or forward bias. Applying a forward bias to a particular section will reduce the optical loss associated with that section, or may result in the section becoming optically transparent, or may result in the section having optical gain. As well as determining the net loss or gain of the device, the biasing conditions of sections that the light passes through after being modulated with data may also influence the chirp of the encoded pulses. The bias levels are optimised for each wavelength of operation so that the device modulation depth, chirp and insertion loss are be adjusted to fall within the specification demanded by the application.

Where no bias or modulation signal is being applied to a particular section of the device, the electrode for that section may be allowed to ‘float’ without application of a zero or other grounding voltage.

The invention includes the case when two or more parallel branches containing waveguide modulators are used to optimise the performance. In this case, the light is split into a number of parallel waveguides, each waveguide containing more than one section of different bandgap. The light from each waveguide is then recombined.

The bandgaps in the different sections of the device are preferably created by quantum well intermixing. This will ensure the optical modes in the different waveguide sections are perfectly aligned at the interface between the sections, and that optical reflections at the interfaces are negligibly small.

The device may advantageously have low-loss waveguides at its input and output. Amongst other benefits, these waveguides will improve optical access to the device by allowing the device to overhang any sub-mount on which it is placed. These waveguides could contain mode tapers and/or optical amplifiers.

The different sections of the device to which voltages are applied may advantageously be separated by lengths of passive low-loss waveguide. These passive waveguides improve electrical isolation between the different electrically driven sections.

The different sections of the device to which voltages are applied may advantageously be graded in bandgap along the length of the waveguide.

It will be understood that the device may be manufactured on a semi-insulating substrate to improve the high frequency response of the modulators. It will also be understood that the modulators may be travelling wave devices that match the velocities of the electrical and optical waves.

FIG. 1 illustrates the principle of the quantum confined Stark effect. For the purposes of illustration, it is assumed that the QW is composed of InGaAs and the barriers of InGaAsP. In a QW structure, the effective bandgap is determined by the fundamental material bandgap of the QW and the quantisation energies of the electron and hole levels. The effective bandgap, E_{g1}, is shown in FIG. 1(a). When an electric field is applied to the device perpendicular to the well (FIG. 1(b)), the effective bandgap is reduced (E_{g2}), and the absorption spectrum changes (FIG. 1(c)). The change in the absorption causes a change in refractive index spectrum.

FIG. 2 shows a cross section through the axial length of the waveguide of the device. The EAM is split into sections 201, 202, 203, 204, 205, each with a different bandgap and in which each bandgap section is addressed by a separate electrode. The device may advantageously have low-loss waveguides 211, 212 at its input and output. The different sections of the device to which voltages are applied may advantageously be separated by lengths of passive low-loss waveguide, 220.

FIG. 3 shows a cross section through the device perpendicular to the waveguide. The layer structure confines light in the vertical direction. FIG. 3 shows a ridge feature used to confine the light in the lateral direction, but it will be appreciated that other methods of providing confinement for the light including buried heterostructures or antiresonant transverse waveguides could be used.

FIG. 4 shows plan views of the device layout (with the contacts not shown for clarity). FIG. 4(a) shows a device with a sequence of different bandgap region formed sequentially along a single waveguide. FIG. 4(b) shows two parallel branches containing waveguide modulators. In this case, the light is split into two parallel waveguides, each waveguide containing more than one section of different bandgap. The light from each waveguide is then recombined.

Other embodiments are intentionally within the scope of the accompanying claims.

1. An electro-absorption modulator comprising a waveguiding structure including a plurality of sections, each section having a different bandgap and at least one electrode for applying electrical bias to the section.

2. The electro-absorption modulator of claim 1 in which the plurality of sections of said waveguiding structure are arranged in a series configuration.

3. The electro-absorption modulator of claim 1 in which the plurality of sections of said waveguiding structure are arranged in a parallel configuration.

4. The electro-absorption modulator of claim 1 in which at least some of the plurality of sections of said waveguiding structure are separated by lengths of passive waveguide.

5. The electro-absorption modulator of claim 1 further including a low loss waveguide at an input and/or an output thereof.

6. The electro-absorption modulator of claim 1 further including at least one additional optically active device incorporated into the waveguiding structure.

7. The electro-absorption modulator of claim 6 in which the additional optically active device in said waveguiding structure comprises an optical amplifier.

8. The electro-absorption modulator of claim 4 in which the lengths of passive waveguide are formed using quantum well intermixing techniques.

9. The electro-absorption modulator of claim 1 in which the plurality of sections of said waveguiding structure are graded in bandgap along the length of the waveguide.

10. A method of modulating an optical signal passing through a waveguiding structure having a plurality of separately addressable sections, each section being formed from a semiconductor medium having a predetermined bandgap and an electrode for biasing said medium, the method comprising the step of:
electrically biasing one or more of said sections with a bias voltage in such a manner as to achieve a predetermined level of any one or more of the parameters chirp, modulation depth and insertion loss.

11. The method of claim 10 further comprising the step of electrically biasing two or more of said sections with a bias voltage in such a manner as to achieve a predetermined level of any one or more of the parameters chirp, modulation depth and insertion loss.

12. The method of claim 10 further comprising the step of electrically biasing all of said sections with a bias voltage in such a manner as to achieve a predetermined level of any one or more of the parameters chirp, modulation depth and insertion loss.

13. The method of claim 10 in which the applied electrical bias to each of said electrically biased sections is one of a reverse bias voltage, a zero bias voltage and a forward bias voltage.

14. The method of claim 10 in which the electrical bias applied to each of said sections is determined in order to minimise chirp.

15. The method of claim 10 further including the step of applying a modulation signal to at least one of said sections.

16. The method of claim 10 further including the step of applying a modulation signal to two or more of said sections.

17. The method of claim 10 further including the step of applying a modulation signal to a biased one of said sections.
